(19) United States
(12) Patent Application Publication
(10) Pub. No.: US 2026/0221083 A1
(43) Pub. Date: Jul. 30, 2026

(54) DISPLAY DRIVER, DISPLAY DEVICE INCLUDING THE DISPLAY DRIVER, AND ELECTRONIC DEVICE INCLUDING THE DISPLAY DEVICE

(71) Applicant: Samsung Display Co., LTD., Yongin-si (KR)

(72) Inventors: JONGMAN KIM, Yongin-si (KR); BYEONG-DOO KANG, Yongin-si (KR); BYOUNGKWAN AN, Yongin-si (KR); KYOUNGHO LIM, Yongin-si (KR); JOONHYEOK JEON, Yongin-si (KR); Jaehee JO, Yongin-si (KR)

(21) Appl. No.: 19/391,062

(22) Filed: Nov. 17, 2025

(30) Foreign Application Priority Data
Jan. 24, 2025 (KR) 10-2025-0010857

(51) Int. Cl. G09G 3/32

(52) U.S. Cl. CPC G09G 3/32; G09G 2320/0257; G09G 2320/045

(57) ABSTRACT

A display driver includes an encoder, a first compensation volatile memory, a nonvolatile memory, and a second compensation volatile memory. The display driver further includes a verification value calculator and a data contamination verificator. The verification value calculator calculates a line count value and a checksum value for encoding compensation data generated based on compensation data. The data contamination verificator calculates a verification checksum value for the encoding compensation data using the line count value, and compares the verification checksum value with the checksum value to verify a data contamination of the encoding compensation data.

This application claims priority to Korean Patent Application No. 10-2025-0010857, filed on January 24, 2025, and all the benefits accruing therefrom under 35 U.S.C. §119, the content of which in its entirety is herein incorporated by reference.

### BACKGROUND

### 1. Field

Embodiments of the invention relate to a display driver, a display device including the display driver, and an electronic device including the display device. More particularly, embodiments of the invention relate to a display driver, a display device including the display driver, and an electronic device including the display device for performing an image sticking compensation.

### 2. Description of the Related Art

In general, a display device includes a display panel and a display driver. The display panel may include gate lines, data lines, and pixels. The display driver may include a gate driver for providing a gate signal to the gate lines, a data driver for providing a data voltage to the data lines, and a driving controller for controlling the gate driver and the data driver. The display driver may further include a nonvolatile memory and a volatile memory.

### SUMMARY

Pixels of a display device may deteriorate over a time. When the pixels deteriorate, an image sticking may be recognized on a display panel of the display device. To prevent the image sticking from being recognized, a display driver of the display device may compensate for input image data based on compensation data to generate a data signal, and the compensation data may be stored in the nonvolatile memory and the volatile memory and input/output. When the compensation data are contaminated during a process of inputting/outputting the compensation data from the volatile memory, an image sticking compensation may be difficult to perform normally.

Embodiments of the invention provide a display driver for verifying a data contamination of compensation data.

Embodiments of the invention provide a display device including the display driver.

Embodiments of the invention provide an electronic device including the display device.

In an embodiment of a display driver according to the invention, the display driver includes an encoder which encodes compensation data to generate encoding compensation data, a verification value calculator which performs a line count on the encoding compensation data received from the encoder to calculate a line count value and performs a checksum on the encoding compensation data received from the encoder to calculates a checksum value, a first compensation volatile memory which stores the encoding compensation data received from the encoder and stores the line count value and the checksum value received from the verification value calculator, a nonvolatile memory which stores the encoding compensation data, the line count value, and the checksum value received from the first compensation volatile memory, a second compensation volatile memory which stores the encoding compensation data, the line count value, and the checksum value received from the nonvolatile memory, and a data contamination verificator which performs the checksum on the encoding compensation data received from the second compensation volatile memory using the line count value received from the second compensation volatile memory to calculate a verification checksum value, and compares the verification checksum value with the checksum value received from the second compensation volatile memory to verify data contamination of the encoding compensation data received from the second compensation volatile memory.

In an embodiment, when the verification checksum value is equal to the checksum value received from the second compensation volatile memory, the data contamination verificator may determine that the encoding compensation data received from the second compensation volatile memory is not contaminated.

In an embodiment, when the verification checksum value is equal to the checksum value received from the second compensation volatile memory, the data contamination verificatory may output the encoding compensation data.

In an embodiment, when the verification checksum value is different from the checksum value received from the second compensation volatile memory, the data contamination verificator may determine that the encoding compensation data received from the second compensation volatile memory is contaminated.

In an embodiment, when the verification checksum value is different from the checksum value received from the second compensation volatile memory, the data contamination verificator may determine the second compensation volatile memory to be defective.

In an embodiment, the encoding compensation data, the line count value, and the checksum value stored in each of the first compensation volatile memory, the nonvolatile memory, and the second compensation volatile memory may be included in one data.

In an embodiment, the data contamination verificator may detect a position of the encoding compensation data included in the one data using the line count value received from the second compensation volatile memory.

In an embodiment, the nonvolatile memory may include a first compensation nonvolatile memory and a second compensation nonvolatile memory, and the one data including the encoding compensation data, the line count value, and the checksum value received from the first compensation volatile memory may be alternately stored in the first compensation nonvolatile memory and the second compensation nonvolatile memory.

In an embodiment, when the first compensation nonvolatile memory stores N-th encoding compensation data, an N-th line count value, and an N-th checksum value, the second compensation nonvolatile memory may store (N+1)-th encoding compensation data, an (N+1)-th line count value, and an (N+1)-th checksum value, and the data contamination verificator may determine that the (N+1)-th encoding compensation data is not contaminated, the data contamination verificator may output the (N+1)-th encoding compensation data, where N is a positive integer greater than or equal to 1.

In an embodiment, when the data contamination verificator determines that the (N+1)-th encoding compensation data is contaminated, the data contamination verificatory may verify the data contamination of the N-th encoding compensation data.

In an embodiment, when the data contamination verificator determines that the N-th encoding compensation data is not contaminated, the data contamination verificator may output the N-th encoding compensation data.

In an embodiment, when the data contamination verificator determines that the N-th encoding compensation data is contaminated, the data contamination verificator may determine that the second compensation volatile memory is defective.

In an embodiment, the display driver may further include a decoder which decodes the encoding compensation data to generate the compensation data.

In an embodiment, the display driver may further include an image sticking compensator which compensates for input image data based on the compensation data to generate a data signal.

In an embodiment, the display driver may further include a stress data volatile memory which stores stress data generated based on the input image data or the data signal.

In an embodiment, the nonvolatile memory may further store accumulated stress data, and the accumulated stress data may be updated based on the stress data received from the stress data volatile memory.

In an embodiment, the display driver may further include a data converter which converts the accumulated stress data into the compensation data.

In an embodiment of a display device according to the invention, the display device include an encoder which encodes compensation data to generate encoding compensation data, a verification value calculator which performs a line count on the encoding compensation data received from the encoder to calculate a line count value and performs a checksum on the encoding compensation data received from the encoder to calculates a checksum value, a first compensation volatile memory which stores the encoding compensation data received from the encoder and stores the line count value and the checksum value received from the verification value calculator, a nonvolatile memory which stores the encoding compensation data, the line count value, and the checksum value received from the first compensation volatile memory, a second compensation volatile memory which stores the encoding compensation data, the line count value, and the checksum value received from the nonvolatile memory, a data contamination verificator which performs the checksum on the encoding compensation data received from the second compensation volatile memory using the line count value received from the second compensation volatile memory to calculate a verification checksum value, and compares the verification checksum value with the checksum value received from the second compensation volatile memory to verify data contamination of the encoding compensation data received from the second compensation volatile memory, and a data driver which generates a data voltage based on a data signal generated by compensating for input image data based on the compensation data and outputs the data voltage to the pixel.

In an embodiment, the encoding compensation data, the line count value, and the checksum value stored in each of the first compensation volatile memory, the nonvolatile memory, and the second compensation volatile memory may be included in one data.

In an embodiment of a display device according to the invention, the display device includes an encoder which encodes compensation data to generate encoding compensation data, a verification value calculator which performs a line count on the encoding compensation data received from the encoder to calculate a line count value and performs a checksum on the encoding compensation data received from the encoder to calculates a checksum value, a first compensation volatile memory which stores the encoding compensation data received from the encoder and stores the line count value and the checksum value received from the verification value calculator, a nonvolatile memory which stores the encoding compensation data, the line count value, and the checksum value received from the first compensation volatile memory, a second compensation volatile memory which stores the encoding compensation data, the line count value, and the checksum value received from the nonvolatile memory, a data contamination verificator which performs the checksum on the encoding compensation data received from the second compensation volatile memory using the line count value received from the second compensation volatile memory to calculate a verification checksum value, and compares the verification checksum value with the checksum value received from the second compensation volatile memory to verify data contamination of the encoding compensation data received from the second compensation volatile memory, a data driver which generates a data voltage based on a data signal generated by compensating for input image data based on the compensation data and outputs the data voltage to the pixel, and a processor which outputs the input image data.

According to embodiments of the display driver, the display device, and the electronic device, the display driver may include the verification value calculator and the data contamination verificator. The verification value calculator may calculate the line count value and the checksum value for the encoding compensation data generated based on the compensation data. The data contamination verificator may calculate the verification checksum value for the encoding compensation data using the line count value, and may compare the verification checksum value with the checksum value to verify the data contamination of the encoding compensation data. Accordingly, the input image data may be accurately compensated.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram showing a display device according to embodiments of the invention;

FIG. 2 is a block diagram showing a comparative example of a display driver of FIG. 1;

FIG. 3 is a block diagram showing an embodiment of a display driver of FIG. 1;

FIG. 4 and FIG. 5 are diagrams showing an operation of an embodiment of a display driver of FIG. 3;

FIGS. 6 to 8 are diagrams showing an embodiment of a display driver of FIG. 1;

FIG. 9 is a block diagram showing an electronic device according to an embodiment of the invention;

FIG. 10 is a diagram showing an embodiment in which an electronic device of FIG. 9 is implemented as a smart phone;

FIG. 11 is a block diagram showing an electronic device 10 according to an embodiment of the invention; and

FIG. 12 is schematic diagrams showing the electronic devices of FIG. 11.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

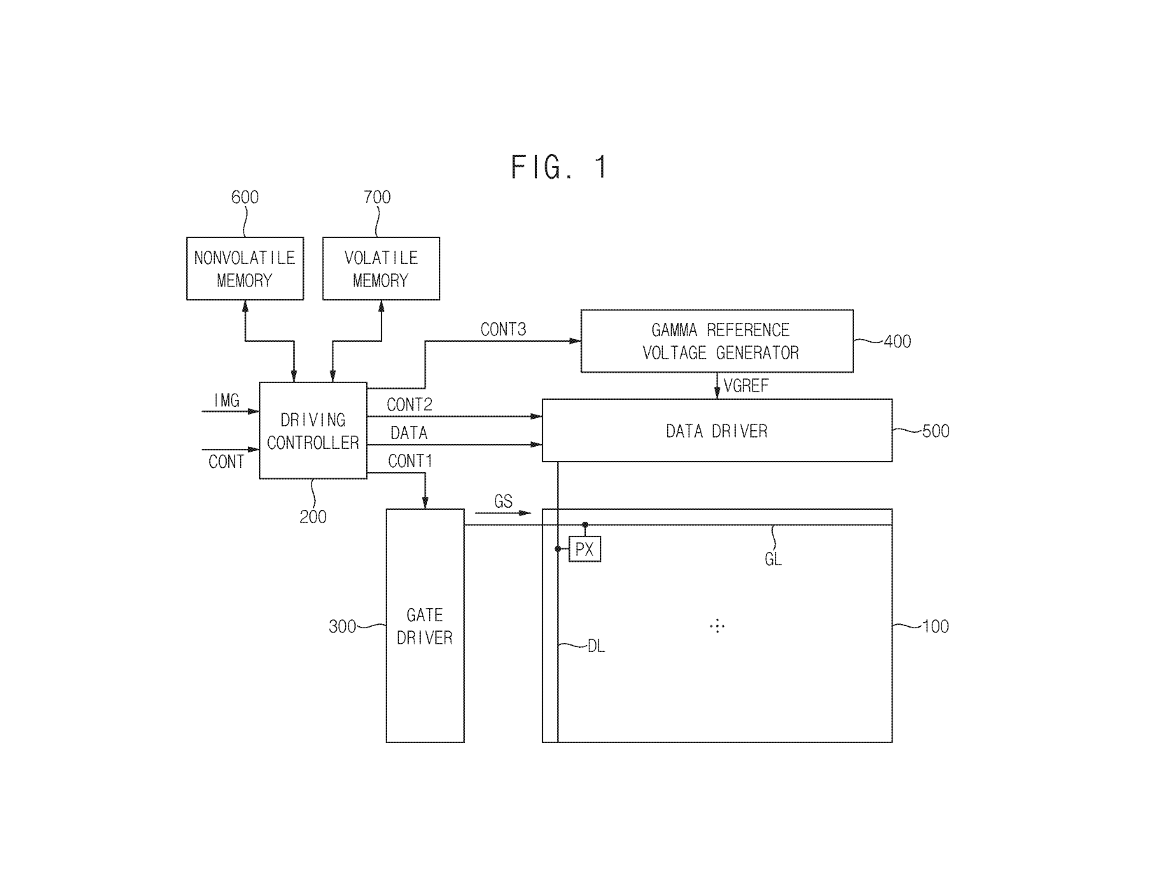

FIG. 1 is a block diagram showing a display device according to embodiments of the invention.

Referring to FIG. 1, an embodiment of a display device may include a display panel 100 and a display driver. The display driver may include a driving controller 200, a gate driver 300, a gamma reference voltage generator 400, and a data driver 500. In an embodiment, the display driver may further include a nonvolatile memory 600 and a volatile memory 700.

In an embodiment, for example, the driving controller 200 and the data driver 500 may be formed integrally with each other as a single unit or module, e.g., a single chip. In an embodiment, for example, the driving controller 200, the gamma reference voltage generator 400, and the data driver 500 may be formed integrally with each other as a single unit or module, e.g., a single chip. A driving module in which at least the driving controller 200 and the data driver 500 are formed integrally may be referred to as a timing controller embedded data driver (TED).

The display panel 100 may include a display area for displaying an image and a peripheral area disposed adjacent to the display area.

In an embodiment, for example, in an embodiment, the display panel 100 may be an organic light emitting diode display panel including an organic light emitting diode. In an embodiment, for example, the display panel 100 may be a quantum-dot organic light emitting diode display panel including an organic light emitting diode and a quantum-dot color filter. In an embodiment, for example, the display panel 100 may be a quantum-dot nano light emitting diode display panel including a nano light emitting diode and a quantum-dot color filter.

The display panel 100 may include gate lines GL, data lines DL, and pixels PX electrically connected to the gate lines GL and the data lines DL, respectively. The gate lines GL may extend in a first direction, and the data lines DL may extend in a second direction crossing the first direction.

The driving controller 200 may receive input image data IMG and an input control signal CONT from an external device. In an embodiment, for example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals GS for driving the gate lines GL in response to the first control signal CONT1 received from the driving controller 200. The gate driver 300 may output the gate signals GS to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

In an embodiment, for example, the gamma reference voltage generator 400 may be disposed within the driving controller 200 or may be disposed within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The nonvolatile memory 600 may store accumulated stress data of each of the pixels PX and compensation data corresponding to the accumulated stress data. Since the accumulated stress data represents a deterioration degree of each of the pixels PX, the accumulated stress data may be stored in the nonvolatile memory 600 not to be erased even when the display device is turned off. The compensation data may be data for compensating for the input image data IMG. In an embodiment, the nonvolatile memory 600 may be implemented as a flash memory, but is not limited thereto.

The volatile memory 700 may receive and store the compensation data from the nonvolatile memory 600 when the display device is turned on. The compensation data stored in the volatile memory 700 may be updated periodically. In an embodiment, the volatile memory 700 may be implemented as a static random access memory (SRAM), a dynamic random access memory (DRAM), a mobile DRAM, etc., but is not limited thereto.

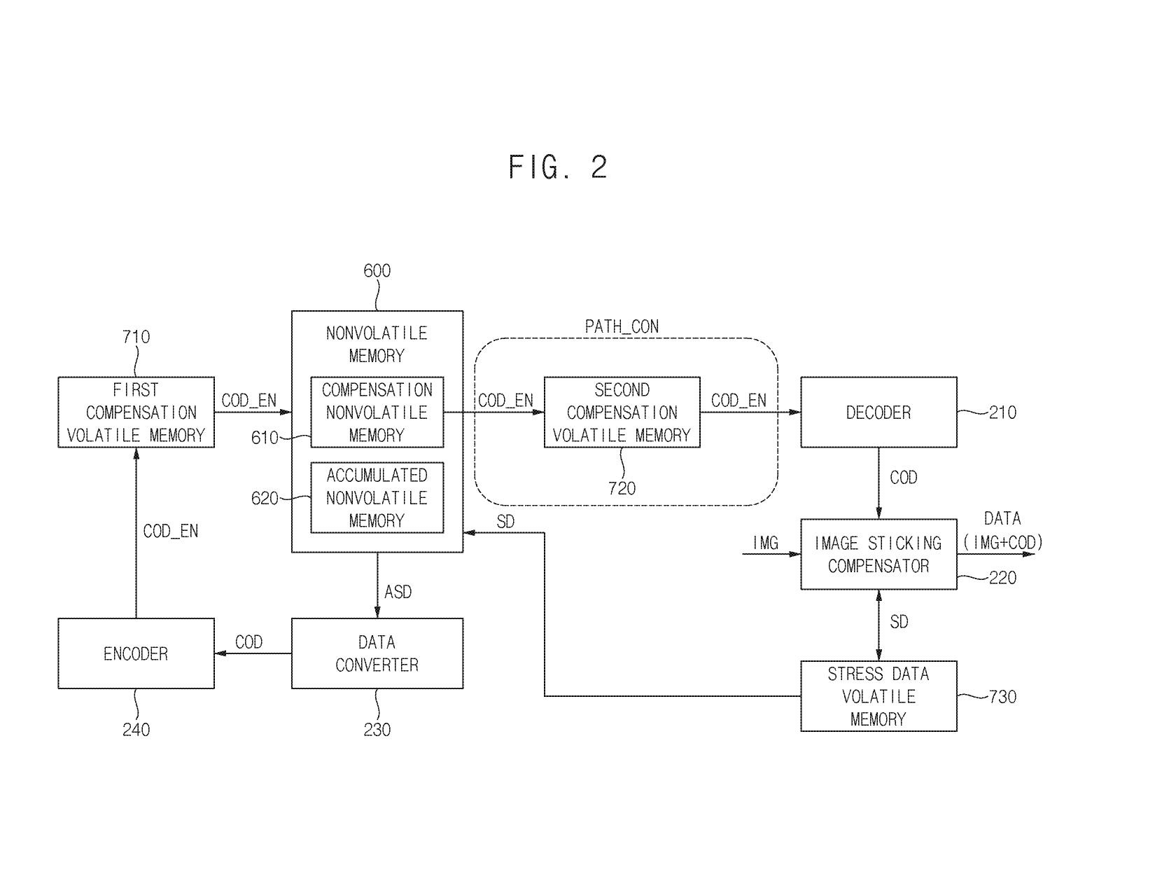

FIG. 2 is a block diagram showing a comparative example of a display driver of FIG. 1.

Referring to FIG. 1 and FIG. 2, a comparative example of a display driver of FIG. 1 may include a decoder 210, an image sticking compensator (or an afterimage compensator) 220, a data converter 230, an encoder 240, a nonvolatile memory 600, a first compensation volatile memory 710, a second compensation volatile memory 720, and a stress data volatile memory 730.

The image sticking compensator 220 may receive compensation data COD from the decoder 210. The image sticking compensator 220 may compensate for input image data IMG based on the compensation data COD received from the decoder 210 to generate a data signal DATA. For example, the image sticking compensator 220 may add the compensation data COD to the input image data IMG to generate the data signal DATA. For example, the image sticking compensator 220 may perform an image sticking compensation on a pixel PX basis.

The stress data volatile memory 730 may store stress data SD generated by accumulating the input image data IMG received by the image sticking compensator 220 or the data signal DATA generated by the image sticking compensator 220. An operation of generating the stress data SD and storing the stress data SD in the stress data volatile memory 730 may be performed in real time while a display device is turned on and operating.

The nonvolatile memory 600 may include a compensation nonvolatile memory 610 and an accumulated nonvolatile memory 620. The compensation nonvolatile memory 610 may store encoding compensation data COD_EN. The accumulated nonvolatile memory 620 may store accumulated stress data ASD. The accumulated stress data ASD stored in the accumulated nonvolatile memory 620 may be updated based on the stress data SD. An operation in which the accumulated stress data ASD is updated based on the stress data SD may be periodically performed while the display device is turned on and operating.

The data converter 230 may convert the accumulated stress data ASD into the compensation data COD. Specifically, the data converter 230 may convert the accumulated stress data ASD updated based on the stress data SD into the compensation data COD.

The encoder 240 may receive the compensation data COD from the data converter 230. The encoder 240 may encode the compensation data COD to generate encoding compensation data COD_EN. When the compensation data COD is encoded, a data size of the encoding compensation data COD_EN may be less than a data size of the compensation data COD.

The first compensation volatile memory 710 may receive the encoding compensation data COD_EN from the encoder 240. The first compensation volatile memory 710 may store the encoding compensation data COD_EN. An operation of generating the encoding compensation data COD_EN and storing the encoding compensation data COD_EN in the first compensation volatile memory 710 may be periodically performed while the display device is turned on and operating.

The second compensation volatile memory 720 may receive the encoding compensation data COD_EN from the nonvolatile memory 600 when the display device is turned on. The second compensation volatile memory 720 may store the encoding compensation data COD_EN.

The decoder 210 may receive the encoding compensation data COD_EN from the second compensation volatile memory 720. The decoder 210 may decode the encoding compensation data COD_EN to generate the compensation data COD. When the encoding compensation data COD_EN is decoded, the data size of the compensation data COD may be greater than the encoding compensation data COD_EN.

In such an example, as described above, the display driver may perform the image sticking compensation. However, the encoding compensation data COD_EN may be contaminated in a contamination path PATH_CON including a path through which the second compensation volatile memory 720 receives the encoding compensation data COD_EN from the nonvolatile memory 600 and a path through which the second compensation volatile memory 720 outputs the encoding compensation data COD_EN to the decoder 210. Accordingly, the compensation data COD generated based on the encoding compensation data COD_EN may not accurately compensate for the input image data IMG.

The display driver according to embodiments of the invention aims to verify a data contamination for the encoding compensation data COD_EN.

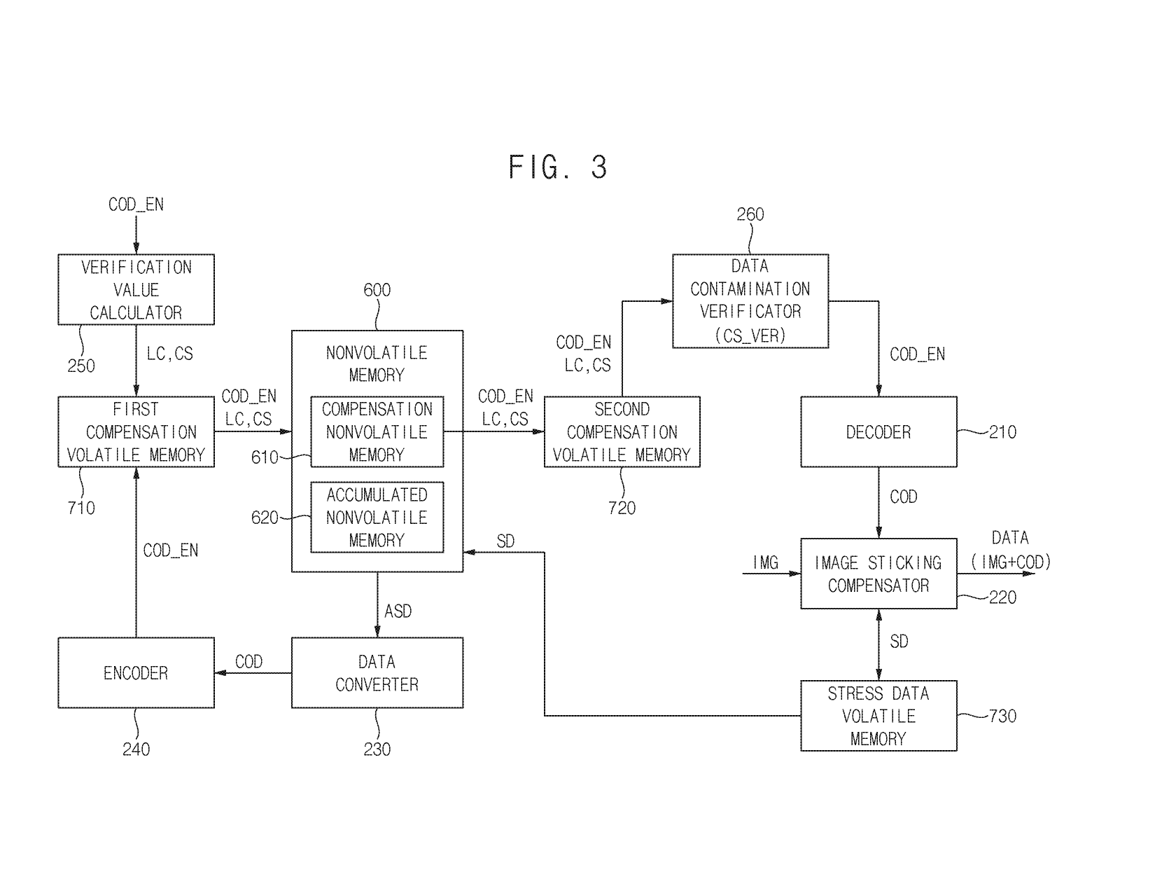

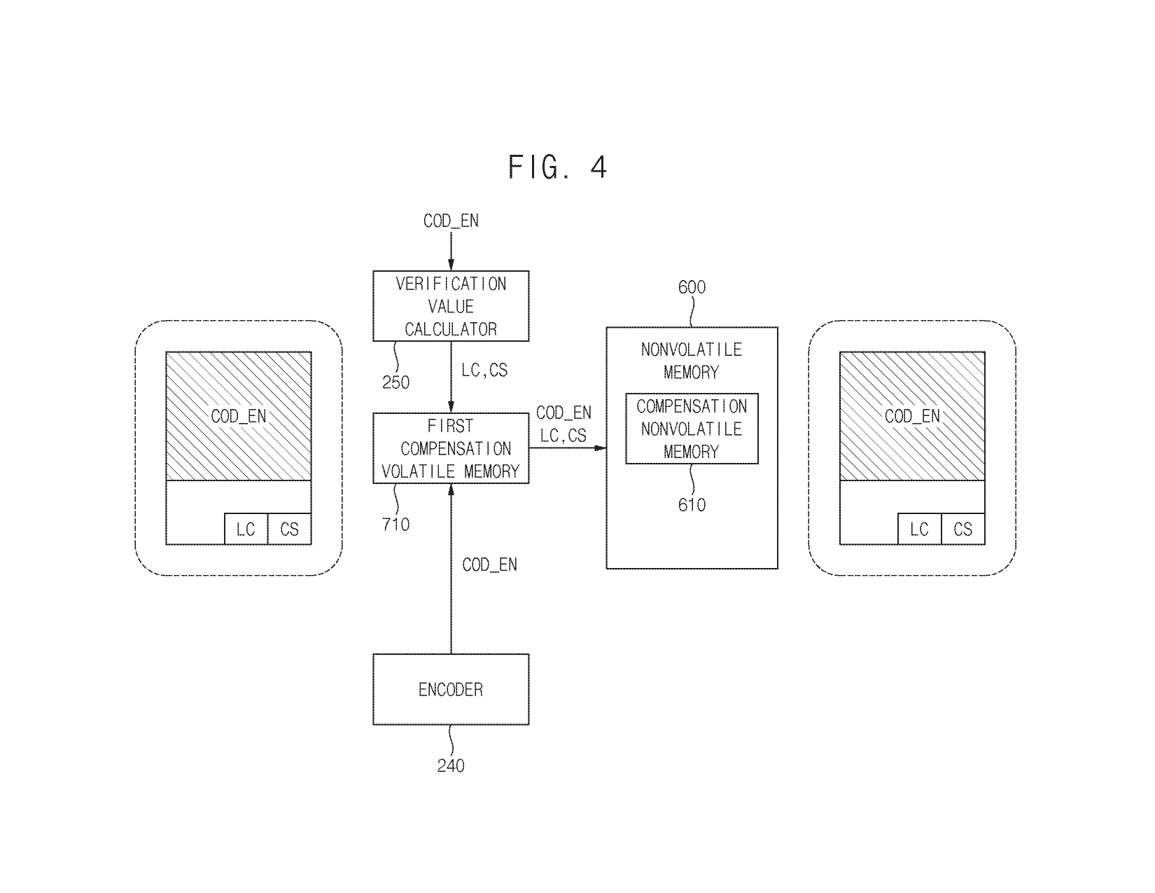

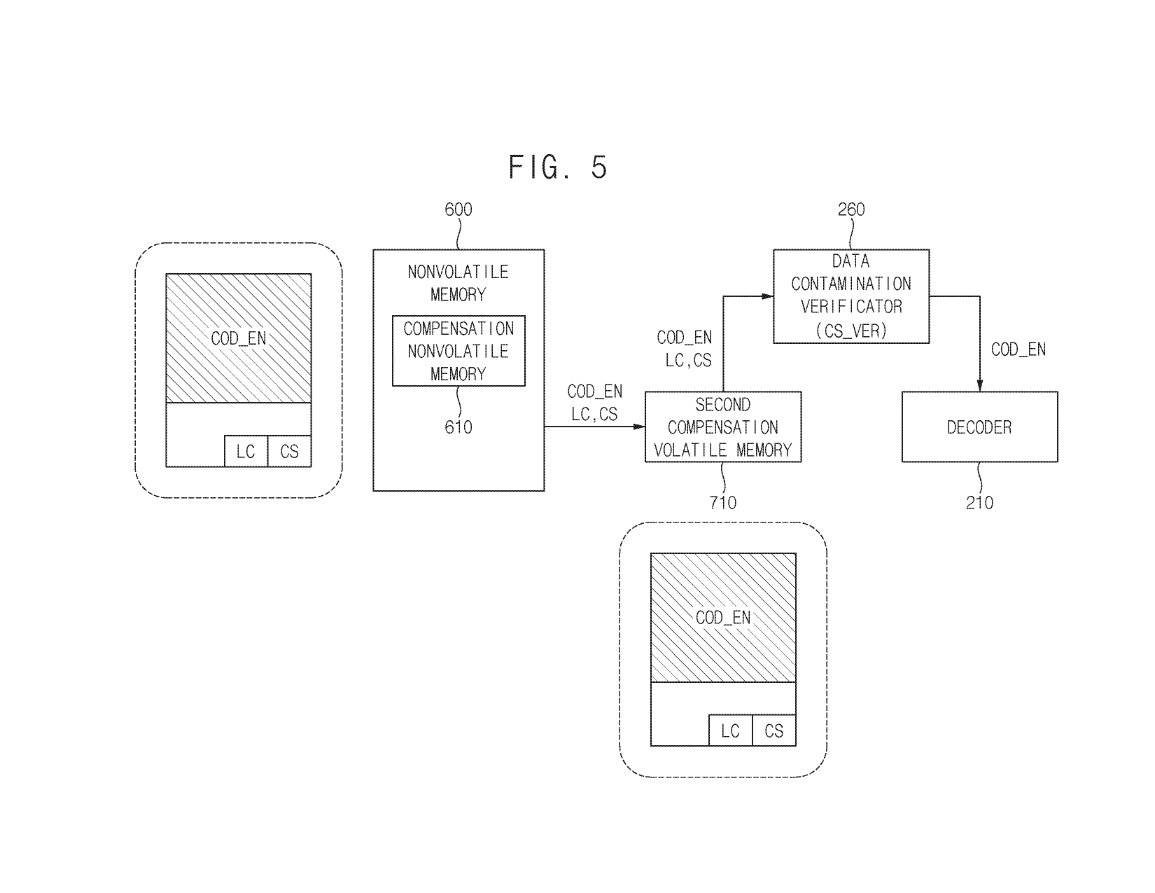

FIG. 3 is a block diagram showing an embodiment of a display driver of FIG. 1. FIG. 4 and FIG. 5 are diagrams showing an operation of an embodiment of a display driver of FIG. 3.

Referring to FIG. 1 to FIG. 5, an embodiment of a display driver of FIG. 1 may include a decoder 210, an image sticking compensator 220, a data converter 230, an encoder 240, a nonvolatile memory 600, a first compensation volatile memory 710, a second compensation volatile memory 720, and a stress data volatile memory 730. In such an embodiment, the display driver of FIG. 1 may further include a verification value calculator 250 and a data contamination verificator 260, unlike the display driver of FIG. 2.

The image sticking compensator 220 may receive compensation data COD from the decoder 210. The image sticking compensator 220 may compensate for input image data IMG based on the compensation data COD received from the decoder 210 to generate a data signal DATA. In an embodiment, for example, the image sticking compensator 220 may add the compensation data COD to the input image data IMG to generate the data signal DATA. In an embodiment, for example, the image sticking compensator 220 may perform an image sticking compensation on a pixel PX basis.

The stress data volatile memory 730 may store stress data SD generated by accumulating the input image data IMG received by the image sticking compensator 220 or the data signal DATA generated by the image sticking compensator 220. An operation of generating the stress data SD and storing the stress data SD in the stress data volatile memory 730 may be performed in real time while the display device is turned on and operating.

The nonvolatile memory 600 may include a compensation nonvolatile memory 610 and an accumulated nonvolatile memory 620. The compensation nonvolatile memory 610 may store encoding compensation data COD_EN. The accumulated nonvolatile memory 620 may store accumulated stress data ASD. The accumulated stress data ASD stored in the accumulated nonvolatile memory 620 may be updated based on the stress data SD. An operation of updating the accumulated stress data ASD based on the stress data SD may be performed periodically while the display device is turned on and operating.

The data converter 230 may convert the accumulated stress data ASD into the compensation data COD. Specifically, the data converter 230 may convert the accumulated stress data ASD updated based on the stress data SD into the compensation data COD.

The encoder 240 may receive the compensation data COD from the data converter 230. The encoder 240 may encode the compensation data COD to generate the encoding compensation data COD_EN. When the compensation data COD is encoded, a data size of the encoding compensation data COD_EN may be less than a data size of the compensation data COD.

In such an embodiment, the verification value calculator 250 may receive the encoding compensation data COD_EN from the encoder 240. The verification value calculator 250 may perform a line count on the encoding compensation data COD_EN received from the encoder 240 to calculate a line count value LC, and may perform a checksum on the encoding compensation data COD_EN received from the encoder 240 to calculate a checksum value CS. Here, the line count represents calculating a total number of lines of data, and the line count is frequently used when analyzing or processing the data. The checksum is a value calculated using a specific algorithm to detect an error that may occur when transmitting or storing the data. In an embodiment, for example, the specific algorithm may be adding values included in the data.

The first compensation volatile memory 710 may receive the encoding compensation data COD_EN from the encoder 240, and may receive the line count value LC and the checksum value CS from the verification value calculator 250. The first compensation volatile memory 710 may store the encoding compensation data COD_EN, the line count value LC, and the checksum value CS. The encoding compensation data COD_EN, the line count value LC, and the checksum value CS may be included in one data. An operation of generating the encoding compensation data COD_EN, the line count value LC, and the checksum value CS and storing the encoding compensation data COD_EN, the line count value LC, and the checksum value CS in the first compensation volatile memory 710 may be periodically performed while the display device is turned on and operating.

The compensation nonvolatile memory included in the nonvolatile memory 600 may store not only the encoding compensation data COD_EN, but also the line count value LC and the checksum value CS. The encoding compensation data COD_EN, the line count value LC, and the checksum value CS may be included in the one data. The nonvolatile memory 600 has a self-verification function. Therefore, it may be assumed that the encoding compensation data COD_EN, the line count value LC, and the checksum value CS stored in the nonvolatile memory 600 are not contaminated.

The second compensation volatile memory 720 may receive the encoding compensation data COD_EN, the line count value LC, and the checksum value CS from the nonvolatile memory 600 when the display device is turned on. The second compensation volatile memory 720 may store the encoding compensation data COD_EN, the line count value LC, and the checksum value CS. The encoding compensation data COD_EN, the line count value LC, and the checksum value CS may be included in the one data.

The data contamination verificator 260 may receive the encoding compensation data COD_EN, the line count value LC, and the checksum value CS from the second compensation volatile memory 720. The data contamination verificator 260 may perform the checksum on the encoding compensation data COD_EN received from the second compensation volatile memory 720 using the line count value LC received from the second compensation volatile memory 720 to calculate a verification checksum value CS_VER. Specifically, since the encoding compensation data COD_EN, the line count value LC, and the checksum value CS are included in the one data, the data contamination verificator 260 may detect a position of the encoding compensation data COD_EN included in the one data using the line count value LC received from the second compensation volatile memory 720. The data contamination verificator 260 may compare the verification checksum value CS_VER with the checksum value CS received from the second compensation volatile memory 720 to verify a data contamination of the encoding compensation data COD_EN received from the second compensation volatile memory 720. Here, the checksum value CS is simply a read value of a value stored in the second compensation volatile memory 720, and the verification checksum value CS_VER is a value which the data contamination verificator 260 recalculates using the line count value LC of the encoding compensation data COD_EN stored in the second compensation volatile memory 720, such that the checksum value CS and the verification checksum value CS_VER may be the same as or different from each other.

In an embodiment, when the verification checksum value CS_VER is equal to the checksum value CS received from the second compensation volatile memory 720, the data contamination verificator 260 may determine that the encoding compensation data COD_EN received from the second compensation volatile memory 720 is not contaminated.

In such an embodiment, when the verification checksum value CS_VER is different from the checksum value received from the second compensation volatile memory, the data contamination verificator 260 may determine that the encoding compensation data COD_EN received from the second compensation volatile memory 720 is contaminated.

In such an embodiment, as described above, the display driver may include the verification value calculator 250 and the data contamination verificator 260. The verification value calculator 250 may calculate the line count value LC and the checksum value CS for the encoding compensation data COD_EN generated based on the compensation data COD. The data contamination verificator 260 may calculate the verification checksum value CS_VER for the encoding compensation data COD_EN using the line count value LC, and may compare the verification checksum value CS_VER with the checksum value CS to verify the data contamination of the encoding compensation data COD_EN. Accordingly, the input image data IMG may be accurately compensated.

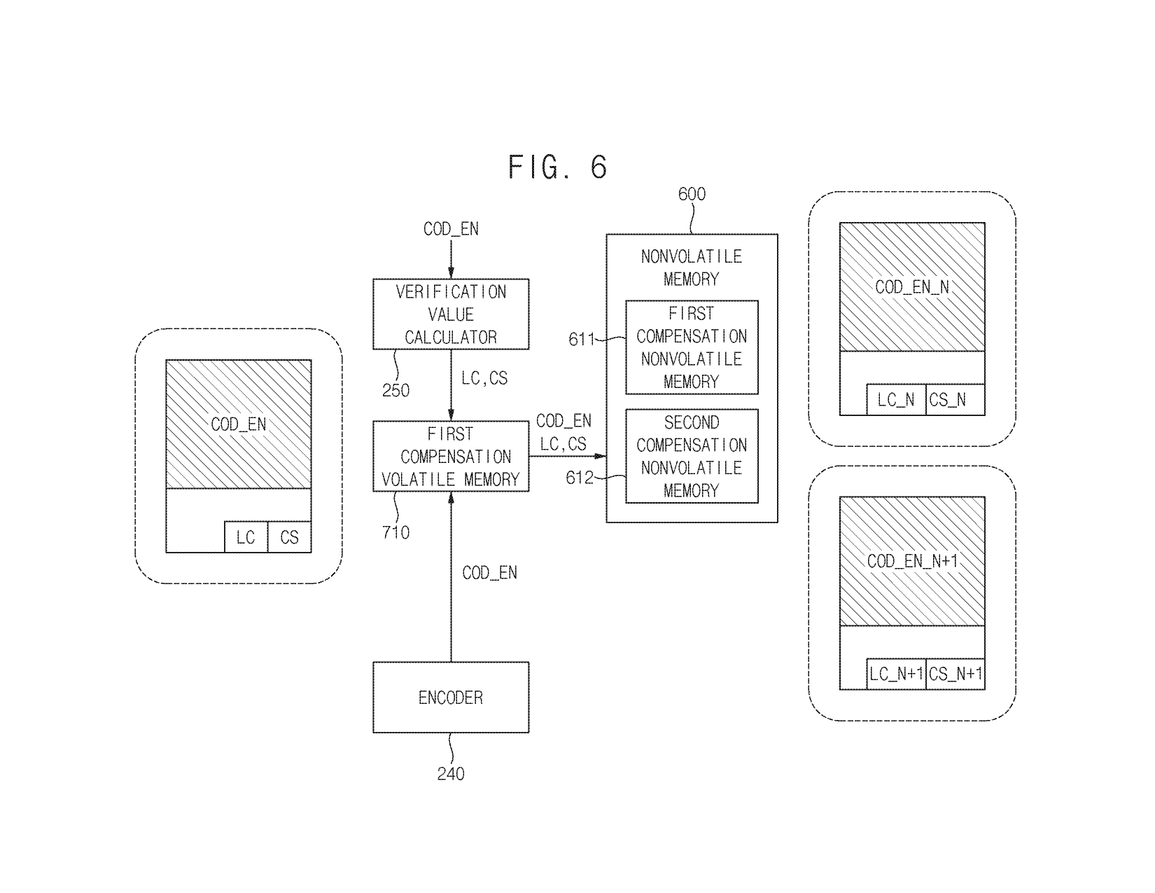

FIGS. 6 to 8 are diagrams showing an embodiment of a display driver of FIG. 1.

Referring to FIGS. 1 to 8, an embodiment of a display driver of FIGS. 6 to 8 may include a decoder 210, an image sticking compensator 220, a data converter 230, an encoder 240, a nonvolatile memory 600, a first compensation volatile memory 710, a second compensation volatile memory 720, and a stress data volatile memory 730. In an embodiment, as shown in FIGS. 6 to 8, the display driver may further include a verification value calculator 250 and a data contamination verificator 260. The nonvolatile memory 600 may include a compensation nonvolatile memory 610 and an accumulated nonvolatile memory 620 like the display driver of FIGS. 3 to 5. The compensation nonvolatile memory 610 may include a first compensation nonvolatile memory 611 and a second compensation nonvolatile memory 612.

In an embodiment, as shown in FIG. 6, the encoder 240 may output encoding compensation data COD_EN.

The verification value calculator 250 may receive the encoding compensation data COD_EN from the encoder 240. The verification value calculator 250 may perform a line count on the encoding compensation data COD_EN received from the encoder 240 to calculate a line count value LC, and may perform a checksum on the encoding compensation data COD_EN received from the encoder 240 to calculate a checksum value CS.

The first compensation volatile memory 710 may receive the encoding compensation data COD_EN from the encoder 240, and may receive the line count value LC and the checksum value CS from the verification value calculator 250. The first compensation volatile memory 710 may store the encoding compensation data COD_EN, the line count value LC, and the checksum value CS. The encoding compensation data COD_EN, the line count value LC, and the checksum value CS may be included in one data. An operation of generating the encoding compensation data COD_EN, the line count value LC, and the checksum value CS and storing them in the first compensation volatile memory 710 may be performed periodically while the display device is turned on and operating.

In an embodiment, as described above, the compensation nonvolatile memory 610 may include a first compensation nonvolatile memory 611 and a second compensation nonvolatile memory 612. In an embodiment, the one data including the encoding compensation data COD_EN, the line count value LC, and the checksum value CS received from the first compensation volatile memory 710 may be alternately stored in the first compensation nonvolatile memory 611 and the second compensation nonvolatile memory 612.

In an embodiment, for example, the first compensation nonvolatile memory 611 may store N-th encoding compensation data COD_EN_N, an N-th line count value LC_N, and an N-th checksum value CS_N, and a second compensation nonvolatile memory 612 may store an (N+1)-th encoding compensation data COD_EN_N+1, an (N+1)-th line count value LC_N+1, and an (N+1)-th checksum value CS_N+1. Here, N is a positive integer greater than or equal to 1.

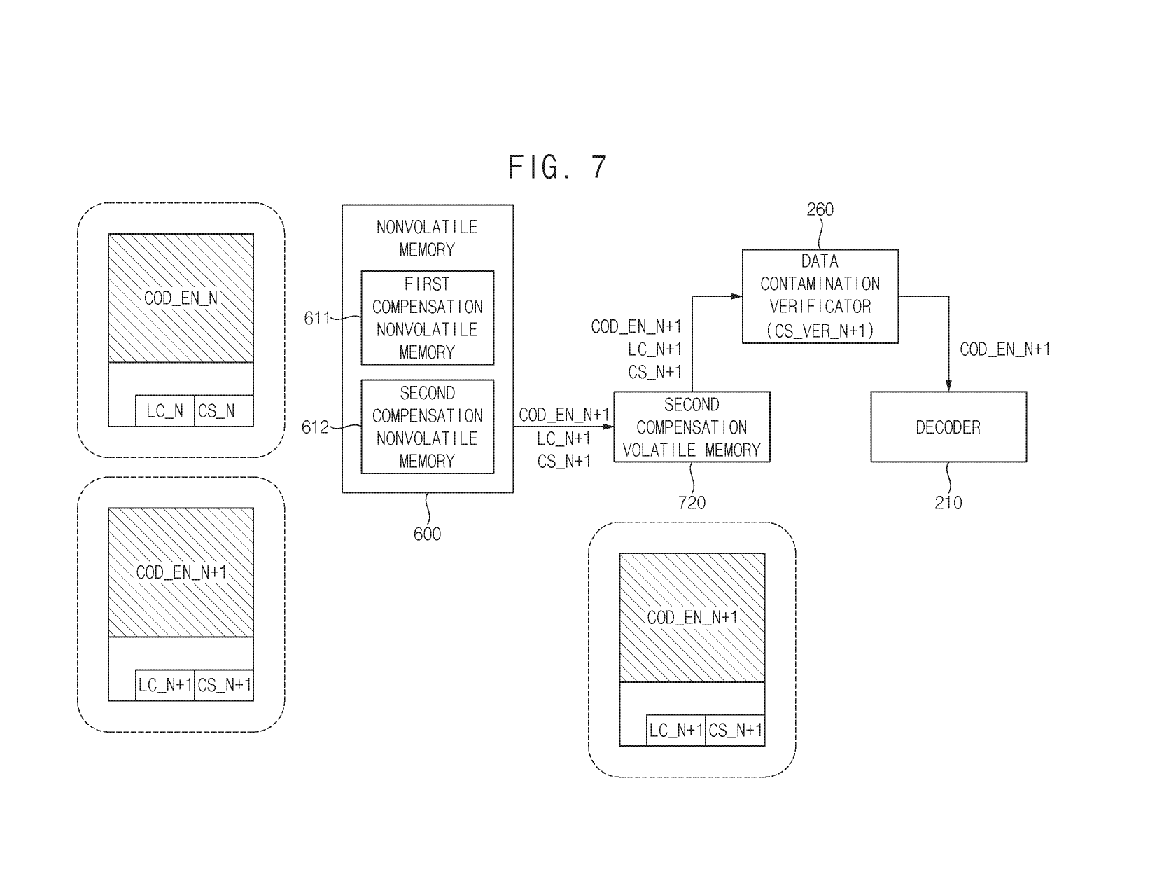

In an embodiment, as shown in FIG. 7, the second compensation volatile memory 720 may receive the (N+1)-th encoding compensation data COD_EN_N+1, the (N+1)-th line count value LC_N+1, and the (N+1)-th checksum value CS_N+1 from the second compensation nonvolatile memory 612 when the display device is turned on. The second compensation volatile memory 720 may store the (N+1)-th encoding compensation data COD_EN_N+1, the (N+1)-th line count value LC_N+1, and the (N+1)-th checksum value CS_N+1 from the second compensation nonvolatile memory 612.

The data contamination verificator 260 may receive the (N+1)-th encoding compensation data COD_EN_N+1, the (N+1)-th line count value LC_N+1, and the (N+1)-th checksum value CS_N+1 from the second compensation volatile memory 720. The data contamination verificator 260 may perform the checksum on the (N+1)-th encoding compensation data COD_EN_N+1 received from the second compensation volatile memory 720 using the (N+1)-th line count value LC_N+1 received from the second compensation volatile memory 720 to calculate an (N+1)-th verification checksum value CS_VER_N+1. The data contamination verificator 260 may verify the data contamination on the (N+1)-th encoding compensation data COD_EN_N+1 received from the second compensation volatile memory 720 by comparing the (N+1)-th verification checksum value CS_VER_N+1 with the (N+1)-th checksum value CS_N+1 received from the second compensation volatile memory 720. Here, the N+1 checksum value CS_N+1 is simply a read value of a value stored in the second compensation volatile memory 720, and the verification checksum value CS_VER is a value recalculated by the data contamination verificator 260 using the N+1 line count value LC_N+1 from the N+1 encoding compensation data COD_EN_N+1 stored in the second compensation volatile memory 720. Therefore, the N+1 checksum value CS_N+1 and the N+1 verification checksum value CS_VER_N+1 may be the same as or different from each other.

In an embodiment, when the (N+1)-th verification checksum value CS_VER_N+1 is equal to the (N+1)-th checksum value CS_N+1 received from the second compensation volatile memory 720, the data contamination verificator 260 may determine that the (N+1)-th encoding compensation data COD_N+1 received from the second compensation volatile memory 720 is not contaminated.

In such an embodiment, when the (N+1)-th verification checksum value CS_VER_N+1 is different from the (N+1)-th checksum value CS_N+1 received from the second compensation volatile memory 720, the data contamination verificator 260 may determine that the (N+1)-th encoding compensation data COD_EN_N+1 received from the second compensation volatile memory 720 is contaminated. In addition, in this case, the data contamination verificator 260 may determine that the second compensation volatile memory 720 is defective.

When the data contamination verificator 260 determines that the (N+1)-th encoding compensation data COD_EN_N+1 is not contaminated, the data contamination verificator 260 may output the (N+1)-th encoding compensation data COD_EN_N+1, and the decoder 210 may receive the (N+1)-th encoding compensation data COD_EN_N+1.

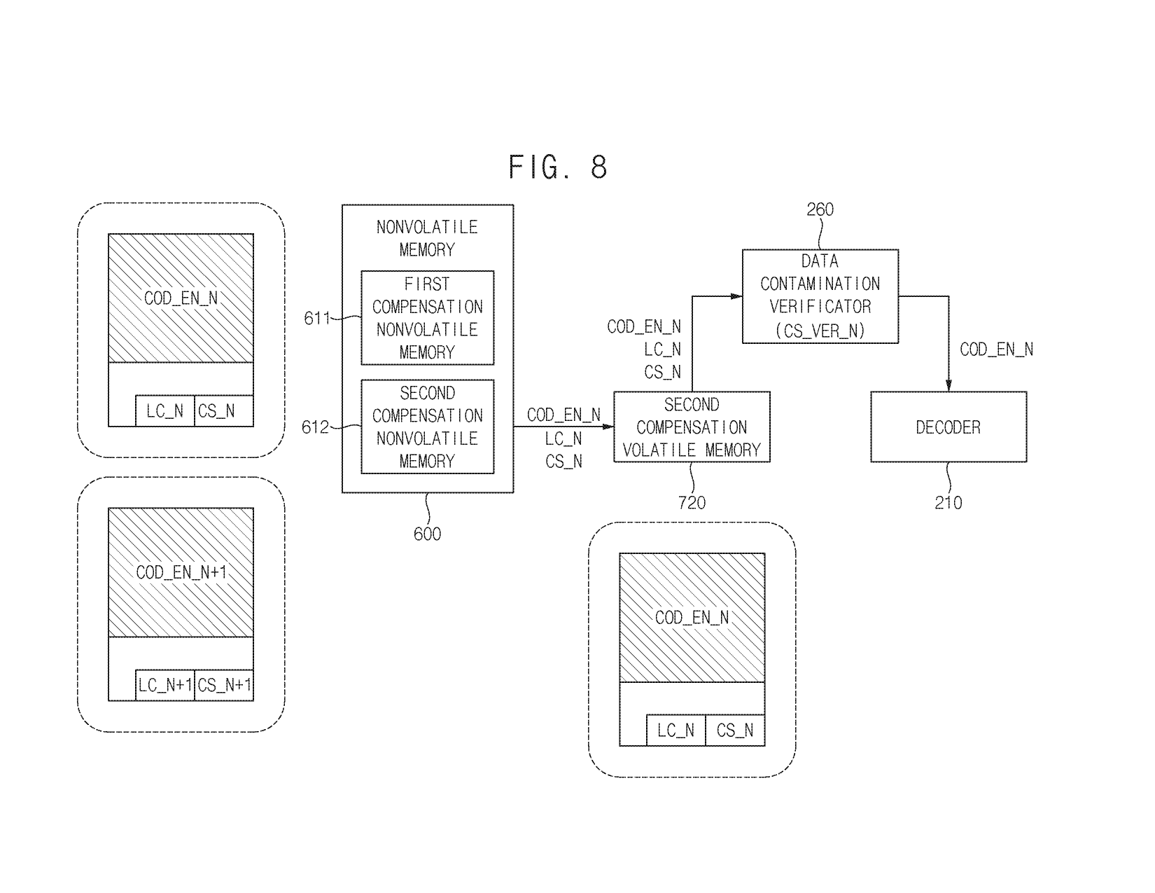

In an embodiment, as shown in FIG. 8, when the data contamination verificator 260 determines that the (N+1)-th encoding compensation data COD_EN_N+1 is contaminated, the second compensation volatile memory 720 may receive the N-th encoding compensation data COD_EN_N, the N-th line count value LC_N, and the N-th checksum value CS_N from the first compensation nonvolatile memory 611. The second compensation volatile memory 720 may store the N-th encoding compensation data COD_EN_N, the N-th line count value LC_N, and the N-th checksum value CS_N from the first compensation nonvolatile memory 611.

The data contamination verificator 260 may receive the N-th encoding compensation data COD_EN_N, the N-th line count value LC_N, and the N-th checksum value CS_N from the second compensation volatile memory 720. The data contamination verificator 260 may perform the checksum on the N-th encoding compensation data COD_EN_N received from the second compensation volatile memory 720 using the N-th line count value LC_N received from the second compensation volatile memory 720 to calculate an N-th verification checksum value CS_VER_N. The data contamination verificator 260 may compare the N-th verification checksum value CS_VER_N with the N-th checksum value CS_N received from the second compensation volatile memory 720 to verify the data contamination of the N-th encoding compensation data COD_EN_N received from the second compensation volatile memory 720. Here, the N-th checksum value CS_N is simply a value read from a value stored in the second compensation volatile memory 720, and the verification checksum value CS_VER is a value recalculated by the data contamination verificator 260 using the N-th line count value LC_N of the N-th encoding compensation data COD_EN_N stored in the second compensation volatile memory 720. Therefore, the N-th checksum value CS_N and the N-th verification checksum value CS_VER_N may be the same or different.

In an embodiment, when the N-th verification checksum value CS_VER_N is equal to the N-th checksum value CS_N received from the second compensation volatile memory 720, the data contamination verificator 260 may determine that the (N+1)-th encoding compensation data COD_N+1 received from the second compensation volatile memory 720 is not contaminated.

In such an embodiment, when the N-th verification checksum value CS_VER_N is different from the N-th checksum value CS_N received from the second compensation volatile memory 720, the data contamination verificator 260 may determine that the N-th encoding compensation data COD_EN_N received from the second compensation volatile memory 720 is contaminated. In addition, in this case, the data contamination verificator 260 may determine that the second compensation volatile memory 720 is defective.

When the data contamination verificator 260 determines that the N-th encoding compensation data COD_EN_N is not contaminated, the data contamination verificator 260 may output the N-th encoding compensation data COD_EN_N, and the decoder 210 may receive the N-th encoding compensation data COD_EN_N. In addition, the contaminated (N+1)-th encoding compensation data COD_EN_N+1 stored in the first compensation nonvolatile memory 611 may be updated to an uncontaminated N+2-th encoding compensation data COD_EN_N+1 in the future.

In such an embodiment, as described above, the display driver may include the verification value calculator 250 and the data contamination verificator 260. The verification value calculator 250 may calculate the line count value LC and the checksum value CS for the encoding compensation data COD_EN generated based on the compensation data COD. The data contamination verificator 260 may calculate the verification checksum value CS_VER for the encoding compensation data COD_EN using the line count value LC, and may compare the verification checksum value CS_VER and the checksum value CS to verify the data contamination for the encoding compensation data COD_EN. Accordingly, the input image data IMG may be accurately compensated.

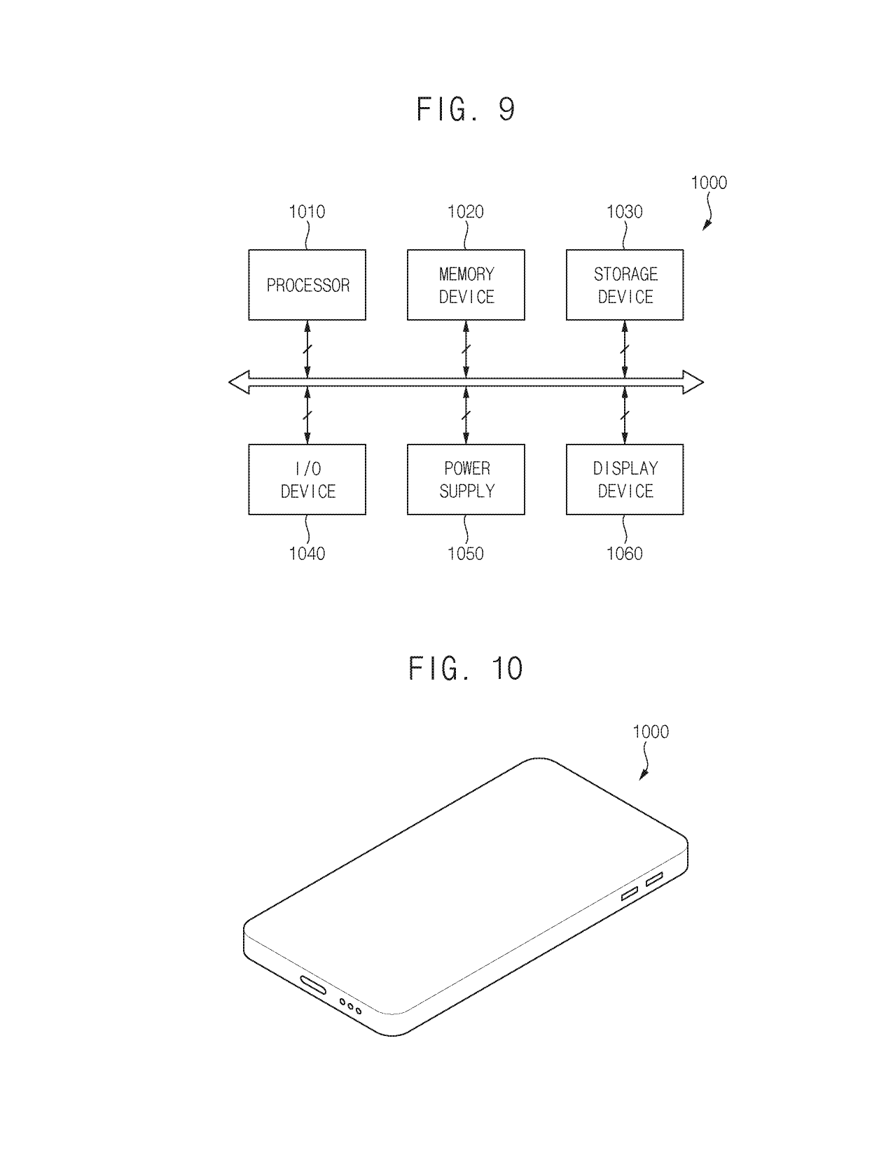

FIG. 9 is a block diagram showing an electronic device 1000 according to an embodiment of the invention. FIG. 10 is a diagram showing an embodiment in which an electronic device 1000 of FIG. 9 is implemented as a smart phone.

Referring to FIGS. 1 to 10, an embodiment of the electronic device 1000 may include a processor 1010, a memory device 1020, a storage device 1030, an input/output (I/O) device 1040, a power supply 1050 and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic devices, etc.

In an embodiment, as shown in FIG. 10, the electronic device 1000 may be implemented as a smart phone. However, the electronic device 1000 is not limited thereto. In an embodiment, for example, the electronic device 1000 may be implemented as a cellular phone, a video phone, a smart pad, a smart watch, a tablet personal computer (PC), a car navigation system, a computer monitor, a laptop computer, a head mounted display (HMD) device, and the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, and the like and an output device such as a printer, a speaker, or the like. In some embodiments, the display device 1060 may be included in the I/O device 1040. The power supply 1050 may provide power for operations of the electronic device 1000. The display device 1060 may be coupled to other components via the buses or other communication links.

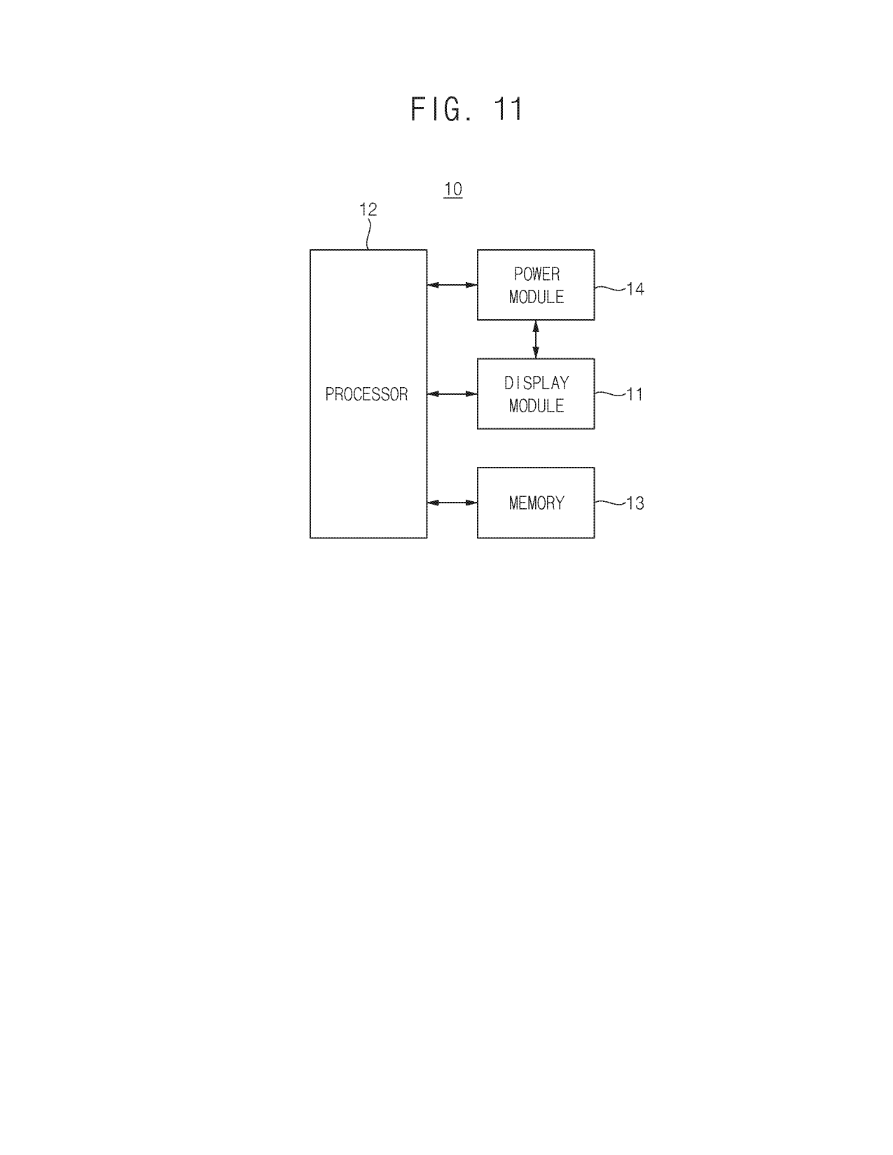

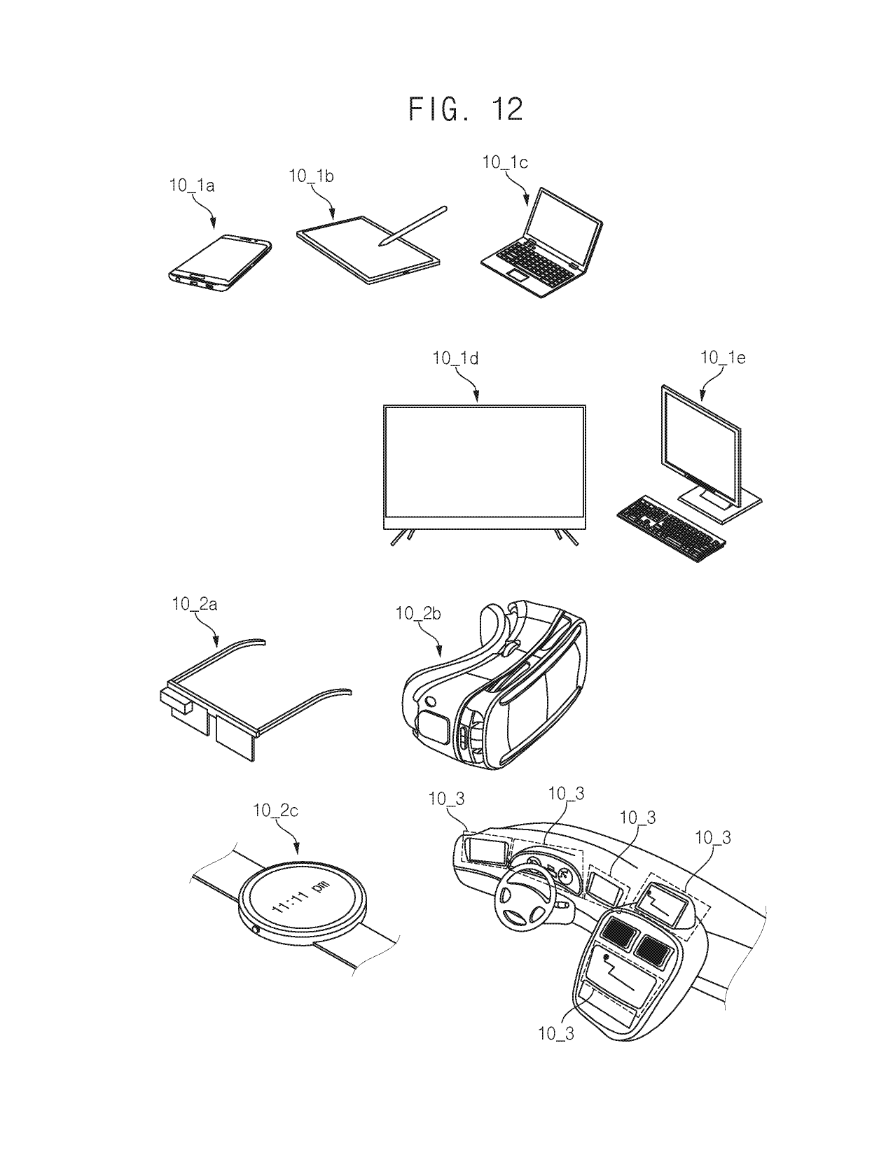

FIG. 11 is a block diagram showing an electronic device 10 according to an embodiment of the invention. FIG. 12 is schematic diagrams showing the electronic devices of FIG. 11.

Referring to FIG. 11, the electronic device 10 according to an embodiment may include a display module 11, a processor 12, a memory 13 and a power module 14.

The display device according to an embodiment of the invention may be applied to various electronic devices.

In an embodiment, the electronic device 10 may include the display device of FIG. 1. An operation of the display device included in the electronic device 10 may be the same as the operation of the display device explained referring to FIGS. 1 to 8. The electronic device 10 may further include a module or an device having additional functions in addition to the display device.

The processor 12 may include at least one selected from a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display device of FIG. 1.

In an embodiment, the processor 12 may be divided into two or more in a functional or structural perspective. In an embodiment, for example, the processor 12 may include a main processor, which is a first driving chip type, including the central processing unit and an auxiliary processor, which is a second driving chip type, including a controller receiving an image signal from the main processor and processing the image signal to match interface specifications of the display module 11. In an embodiment, for example, the auxiliary processor may include the driving controller 200 included in the display device of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one selected from a nonvolatile memory and a volatile memory. Data information used for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power used for the operation of the electronic device 10.

At least one of the elements of the electronic device 10 may be included in the display device according to embodiments of the invention. In addition, a part of a single functional module may be included in the display device and another part of the single functional module may be disposed out of the display device. In an embodiment, for example, the display module 11 may be included in the display device but the processor 12, the memory 13 and the power module 14 may be included in another device in the electronic device 10 which is not the display device.

Referring to FIG. 12, the various electronic devices including the display device according to the present embodiments may include electronic devices for displaying image such as a smartphone 10_1a, a tablet PC 10_1b, a laptop computer 10_1c, a television 10_1d, a desktop monitor 10_1e, wearable electronic devices including a display module such as smart glasses 10_2a, a head mounted display 10_2b and a smart watch 10_2c and vehicle electronic devices 10_3 including display modules such as a center information display (CID), a room mirror display disposed on an instrument panel, center fascia, and a dashboard of a vehicle. The electronic device 10 may not be limited to the electronic devices for displaying image, the wearable electronic devices and the vehicle electronic devices 10_3.

According to embodiments of the driver, the display device including the driver and the electronic device including the driver as described above, the power consumption of the display device may be reduced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display driver, comprising:
an encoder which encodes compensation data to generate encoding compensation data;
a verification value calculator which performs a line count on the encoding compensation data received from the encoder to calculate a line count value and performs a checksum on the encoding compensation data received from the encoder to calculates a checksum value;
a first compensation volatile memory which stores the encoding compensation data received from the encoder and stores the line count value and the checksum value received from the verification value calculator;
a nonvolatile memory which stores the encoding compensation data, the line count value, and the checksum value received from the first compensation volatile memory;
a second compensation volatile memory which stores the encoding compensation data, the line count value, and the checksum value received from the nonvolatile memory; and
a data contamination verificator which performs the checksum on the encoding compensation data received from the second compensation volatile memory using the line count value received from the second compensation volatile memory to calculate a verification checksum value, and compares the verification checksum value with the checksum value received from the second compensation volatile memory to verify data contamination of the encoding compensation data received from the second compensation volatile memory.

2. The display driver of claim 1, wherein when the verification checksum value is equal to the checksum value received from the second compensation volatile memory, the data contamination verificator determines that the encoding compensation data received from the second compensation volatile memory is not contaminated.

3. The display driver of claim 2, wherein when the verification checksum value is equal to the checksum value received from the second compensation volatile memory, the data contamination verificatory outputs the encoding compensation data.

4. The display driver of claim 2, wherein when the verification checksum value is different from the checksum value received from the second compensation volatile memory, the data contamination verificator determines that the encoding compensation data received from the second compensation volatile memory is contaminated.

5. The display driver of claim 4, wherein when the verification checksum value is different from the checksum value received from the second compensation volatile memory, the data contamination verificator determines the second compensation volatile memory to be defective.

6. The display driver of claim 1, wherein the encoding compensation data, the line count value, and the checksum value stored in each of the first compensation volatile memory, the nonvolatile memory, and the second compensation volatile memory are included in one data.

7. The display driver of claim 6, wherein the data contamination verificator detects a position of the encoding compensation data included in the one data using the line count value received from the second compensation volatile memory.

8. The display driver of claim 6, wherein the nonvolatile memory includes a first compensation nonvolatile memory and a second compensation nonvolatile memory, and
wherein the one data including the encoding compensation data, the line count value, and the checksum value received from the first compensation volatile memory is alternately stored in the first compensation nonvolatile memory and the second compensation nonvolatile memory.

9. The display driver of claim 8, wherein when the first compensation nonvolatile memory stores N-th encoding compensation data, an N-th line count value, and an N-th checksum value, the second compensation nonvolatile memory stores (N+1)-th encoding compensation data, an (N+1)-th line count value, and an (N+1)-th checksum value, and the data contamination verificator which determine that the (N+1)-th encoding compensation data is not contaminated, the data contamination verificator which output the (N+1)-th encoding compensation data, wherein N is a positive integer greater than or equal to 1.

10. The display driver of claim 9, wherein when the data contamination verificator which determines that the (N+1)-th encoding compensation data is contaminated, the data contamination verificatory verifies the data contamination of the N-th encoding compensation data.

11. The display driver of claim 10, wherein when the data contamination verificator determines that the N-th encoding compensation data is not contaminated, the data contamination verificator outputs the N-th encoding compensation data.

12. The display driver of claim 11, wherein when the data contamination verificator determines that the N-th encoding compensation data is contaminated, the data contamination verificator determines that the second compensation volatile memory is defective.

13. The display driver of claim 1, wherein the display driver further comprises a decoder which decodes the encoding compensation data to generate the compensation data.

14. The display driver of claim 1, wherein the display driver further comprises an image sticking compensator which compensate for input image data based on the compensation data to generate a data signal.

15. The display driver of claim 14, wherein the display driver further comprises a stress data volatile memory which stores stress data generated based on the input image data or the data signal.

16. The display driver of claim 15, wherein the nonvolatile memory further stores accumulated stress data, and the accumulated stress data is updated based on the stress data received from the stress data volatile memory.

17. The display driver of claim 16, wherein the display driver further comprises a data converter which converts the accumulated stress data into the compensation data.

18. A display device, comprising:
a display panel including a pixel;
an encoder which encodes compensation data to generate encoding compensation data;
a verification value calculator which performs a line count on the encoding compensation data received from the encoder to calculate a line count value and performs a checksum on the encoding compensation data received from the encoder to calculates a checksum value;
a first compensation volatile memory which stores the encoding compensation data received from the encoder and stores the line count value and the checksum value received from the verification value calculator;
a nonvolatile memory which stores the encoding compensation data, the line count value, and the checksum value received from the first compensation volatile memory;
a second compensation volatile memory which stores the encoding compensation data, the line count value, and the checksum value received from the nonvolatile memory;
a data contamination verificator which performs the checksum on the encoding compensation data received from the second compensation volatile memory using the line count value received from the second compensation volatile memory to calculate a verification checksum value, and compares the verification checksum value with the checksum value received from the second compensation volatile memory to verify data contamination of the encoding compensation data received from the second compensation volatile memory; and
a data driver which generates a data voltage based on a data signal generated by compensating for input image data based on the compensation data and outputs the data voltage to the pixel.

19. The display device of claim 18, wherein the encoding compensation data, the line count value, and the checksum value stored in each of the first compensation volatile memory, the nonvolatile memory, and the second compensation volatile memory are included in one data.

20. An electronic device, comprising:
a display panel including a pixel;
an encoder which encodes compensation data to generate encoding compensation data;
a verification value calculator which performs a line count on the encoding compensation data received from the encoder to calculate a line count value and performs a checksum on the encoding compensation data received from the encoder to calculates a checksum value;
a first compensation volatile memory which stores the encoding compensation data received from the encoder and stores the line count value and the checksum value received from the verification value calculator;
a nonvolatile memory which stores the encoding compensation data, the line count value, and the checksum value received from the first compensation volatile memory;
a second compensation volatile memory which stores the encoding compensation data, the line count value, and the checksum value received from the nonvolatile memory;
a data contamination verificator which performs the checksum on the encoding compensation data received from the second compensation volatile memory using the line count value received from the second compensation volatile memory to calculate a verification checksum value, and compares the verification checksum value with the checksum value received from the second compensation volatile memory to verify data contamination of the encoding compensation data received from the second compensation volatile memory;
a data driver which generates a data voltage based on a data signal generated by compensating for input image data based on the compensation data and outputs the data voltage to the pixel; and
a processor which outputs the input image data.
